(19) United States
(12) Patent Application Publication
(10) Pub. No.: US 2020/0406267 A1
(43) Pub. Date: Dec. 31, 2020

(54) STIRRER MILL

(71) Applicant: Bühler AG, Uzwil (CH)

(72) Inventors: Eduard NATER, Uzwil (CH); Andreas RIECHE, Uzwil (CH); Norbert KERN, Uzwil (CH); Achim STURM, Uzwil (CH)

(21) Appl. No.: 16/978,236

(22) PCT Filed: Mar. 5, 2019
(86) PCT No.: PCT/EP2019/055428

§ 371 Date: Sep. 4, 2020

(30) Foreign Application Priority Data
Mar. 7, 2018 (EP) 18160427.3

(51) Int. Cl. B02C 17/16; B02C 17/18

(52) U.S. Cl. CPC B02C 17/161; B02C 17/163; B02C 17/166; B02C 2017/165; B02C 17/184

(57) ABSTRACT

A stirrer mill for the treatment of flowable grinding stock. The stirrer mill includes a milling container, a milling chamber delimited by the container wall, and a stirring mechanism having a rotor which rotates about a central longitudinal axis and has an inside diameter (d351). Tools, which extend toward the container wall, are attached to the rotor. The stirrer mill also includes an internal stator arranged inside the rotor. A grinding stock discharge channel is formed, between the rotor and the internal stator, through which the grinding stock passes to a separating device and, thereafter, to a discharge line. The milling chamber is at least partially filled with grinding bodies having a diameter (c). Above the internal stator is arranged a separating device with a diameter (d30). The distance (s) between the rotor and the grinding body separating device is given by the relationship: s=0.5·(d351−d30)≤5·c.

This application is a national stage completion of PCT/EP2019/055428 filed Mar. 5, 2019 which claims priority from European application serial no. 18160427.3 filed Mar. 7, 2018.

### FIELD OF THE INVENTION

The invention relates to a stirrer mill.

### BACKGROUND OF THE INVENTION

The invention is related to European Patent Specification EP 1 992 412 A1. From that document, a stirrer mill of this type is known. Stirrer mills are used to disperse suspensions, i.e. solids in liquids. This is necessary for example in the production of adhesives, printing inks, cosmetics or pharmaceuticals. For this, the grinding stock is passed by way of a feed channel into a milling chamber of the stirrer mill, which chamber is formed between the outer wall of a rotor and a container wall, and by means of milling-aid bodies such as ceramic balls, also called grinding bodies in what follows, and with the help of tools arranged on the rotor and/or on the container wall, the grinding stock is crushed. By virtue of the stirring movement agglomerates are dispersed and crystal structures are comminuted. During this the original particle size of 100 to 500 μm can be reduced to less than 3 μm. The finished product is then passed via a grinding stock discharge channel to a grinding stock separating device, in particular in the form of a protective sieve, and then on to a discharge line. In this case the rotor forms a kind of rotating cage around the separating device.

In such stirrer mills the grinding bodies should if possible remain only in the milling chamber between the rotor and the container wall. The grinding bodies are accelerated outward and packed together by the tools attached to the rotor, which extend close to the container wall, and by the centrifugal forces produced. If tools are arranged on the container wall, these extend toward the rotor. The tools sometimes arranged on the container wall are preferably arranged offset relative to the tools on the rotor, so that during the rotation of the rotor the tools on it can pass between the tools on the container walls. The grinding stock flows through this dense grinding body packing in the direction of the rotor axis. Owing to the concentration of the grinding bodies in the milling chamber their entry into the grinding stock discharge channel can largely be avoided. In addition to the concentration of grinding bodies in the annular outer milling chamber, devices are provided in the grinding stock discharge channel, which are designed to prevent the grinding bodies from making their way into the separating device.

In the grinding stock discharge channel, which is as a rule arranged inside the rotor and is delimited by the rotor and the internal stator, there are therefore if possible no grinding bodies or only very few of them. Yet, owing to the accretion of grinding bodies against the separating device the pressure in the stirrer mill can increase repeatedly, and this can result in reduced production or even automatic shutdown in order to avoid damage to the stirrer mill. In stirrer mills of the prior art scrapers can be attached to the separating device to keep the grinding bodies away from the separating device. However, during the dispersing of thermally sensitive materials, in particular explosive or other hazardous materials, this may not be desired since owing to the scrapers hot-spots can be produced in the grinding stock.

### SUMMARY OF THE INVENTION

The purpose of the present invention is to avoid the accretion of grinding bodies against the grinding body separating device owing to drag forces, and a resultant clogging of the separating device.

According to the invention this objective is achieved by virtue of the characteristics specified the independent claim(s). The core concept of the invention consists in effectively preventing an accretion of grinding bodies against the separating device by reducing the distance between the rotor and the separating device. This can be done by increasing the diameter of the separating device, i.e. in particular that of the sieve. In particular the distance between the rotor and the separating device can be chosen as a function of the diameter of the grinding bodies, instead of being exclusively determined by the structural dimensions of the stirrer mill. Furthermore, a maximum value can be set for the said distance, which is independent of the size of the grinding bodies. These measures can reduce the aggregation of grinding body accretions produced against the separating device due to drag forces. Thus, production is made more steady and the coarse grains in the product to be dispersed are broken up more rapidly.

In particular, the stated objective is achieved by a stirrer mill having the following characteristics. The stirrer mill comprises a milling container and a milling chamber which is delimited by the container wall, and a stirring mechanism that can rotate about the central longitudinal axis with a rotor having an internal diameter of d351. On the rotor are attached tools which extend toward the container wall. Furthermore, on the container wall second tools can be arranged, which extend toward the rotor. The stirrer mill also comprises an internal stator arranged inside the rotor. Between the rotor and an outer wall of the internal stator a grinding stock discharge channel is formed, through which the grinding stock passes to a separating device and after that to a discharge line. The milling chamber is at least partially filled with grinding bodies having a diameter c. Above the internal stator there is arranged a separating device with a diameter of d30. The size of the distance s between the rotor and the separating device is determined by the difference between the inside diameter of the rotor and the diameter of the separating device. According to the invention, this distance s should be chosen as a function of the diameter c of the grinding bodies, such that s=0.5·(d351−d30)≤5·c. In a second preferred embodiment the distance s can be a function of the diameter c of the grinding bodies s≤3·c. Furthermore, according to an embodiment of the invention the distance s should not exceed the value 2 mm regardless of the size of the grinding bodies.

Preferably, the tools attached to the rotor should leave only a small gap to the wall 9 of the container, this gap having a gap width of b, for which, relative to the diameter c of the grinding bodies, the relationship 4c≤b≤6c applies, wherein the minimum gap width is given by 1.0 mm≤b≤2.0 mm.

On the internal stator scraper tools that extend toward the rotor can be arranged. Preferably these scraper tools, if present, overlap one another in the direction of the central longitudinal axis and are arranged on the internal stator in such manner that when the rotor is driven, they exert an impulse on the grinding bodies in the through-flow direction.

Between the scraper tools and the rotor a gap is preferably formed, for the gap width e of which, relative to the diameter c of the grinding bodies, the relationship 4c≤e≤6c applies, wherein the minimum gap width e is given by 1.0 mm≤c≤2.0 mm.

Furthermore, in the stirring mechanism grinding body return channels are formed for returning the grinding bodies out of the area of the separating device back into the milling chamber.

For the diameter c of the grinding bodies the relationships c≤0.65 mm and preferably 0.02 mm≤c≤0.3 mm apply.

### BRIEF DESCRIPTION OF THE DRAWINGS

Further features, advantages and details emerge from the description of the invention given below, with reference to the drawing, which shows:

FIG. 1: A vertical longitudinal cross-section of a stirring mill according to an embodiment of the invention.

### DETAILED DESCRIPTION OF THE EMBODIMENT

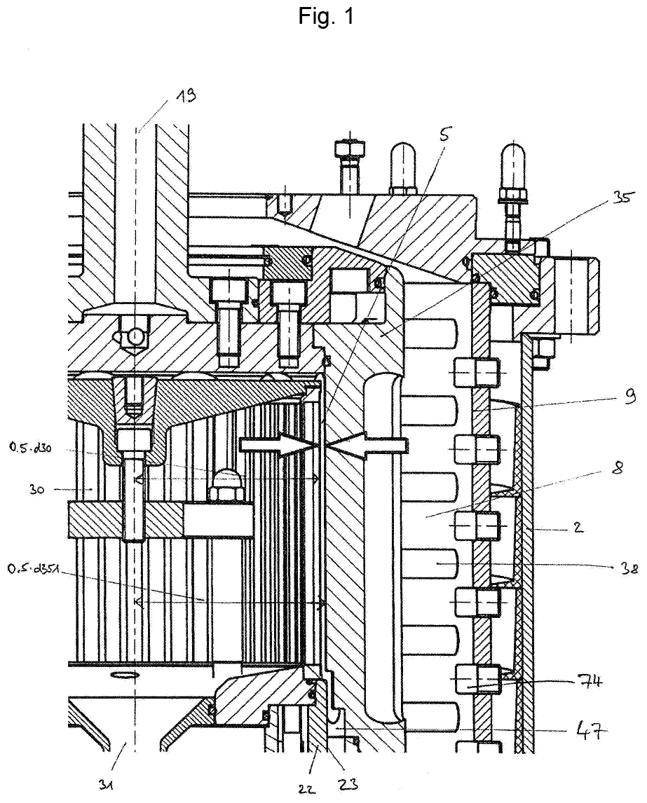

The stirring mill shown in FIG. 1 comprises in the usual manner a milling container 2 with an interior milling chamber 8. The milling chamber 8 is filled at least partially with grinding bodies 43 (not shown) having a diameter of c. The stirring mill also comprises an internal stator 22 and a rotor 35 that can rotate about a central longitudinal axis 19, the rotor 35 having a diameter of d351. In this case a grinding stock discharge channel 47 is formed between an outer wall 23 of the stator 22 and the rotor 35. Onto the rotor 35 are attached tools 38, which project into the milling chamber 8. In addition, on the container wall 9 are attached second tools 74, which are offset relative to the tools attached to the rotor 35. Above the stator 22 there is arranged in the form of a protective sieve 30 a separating device, which is formed to be rotationally symmetrical relative to the central longitudinal axis 19. The protective sieve 30 prevents grinding bodies 43 from flowing through to a downstream discharge line 31, which is located inside the internal stator 22. Between the protective sieve 30 and the rotor 35 there is a distance s. This distance s can be described by the relationship:

s=0.5·(d351−d30)

and can be set in particular by selecting the diameter d30 of the protective sieve 30.

If the dimensions of the stirrer mill were increased, until now the distance s between the protective sieve 30 and the rotor 35 was also chosen correspondingly larger. However, unexpectedly this does not result in a proportional increase of the production flow. Rather, production remains below expectations.

The reason for this is that during operation it can happen that due to drag forces and despite a device for holding back the grinding bodies 43, the latter aggregate against the protective sieve 30. This can result in a reduction of the through-flow or even to complete clogging of the sieve.

In order to effectively prevent this, the distance s between the protective sieve 30 and the rotor 35 is reduced. Here, regardless of the structure of the stirrer mill, the distance s can be chosen as a function of the diameter c of the grinding bodies. This results in greater permeability of the stirrer mill, since the risk that grinding bodies 43 might aggregate against the protective sieve 30 is reduced, and hence the breaking up of coarse grains in the product to be dispersed is more rapid.

According to the invention, the distance s between the protective sieve 30 and the rotor 35, as a function of the grinding body diameter c, is given by:

s≤5·c

or

0.5·(d351−d30)≤5·c.

In a further preferred embodiment the distance s between the protective sieve 30 and the rotor 35, as a function of the grinding body diameter c, is given by:

s≤3·c.

In a further preferred embodiment, even independently of the size of the grinding bodies the distance s is no larger than 2 mm.

Although the previously outlined example embodiment of a stirrer mill shows a vertical central longitudinal axis 19, the designs described can be used without problems in a horizontal position or in a position between those positions.

1-11. (canceled)

12. A stirrer mill for the treatment of flowable grinding stock, comprising:
a milling container and a milling chamber, which is delimited by a container wall, and
a stirring mechanism having a rotor that can rotate about a central longitudinal axis, the said rotor having a diameter (d351),
wherein tools are attached to the rotor, which tools extend in a direction toward the container wall,
an internal stator, which is arranged inside the rotor,
between the rotor and an outer wall of the internal stator a grinding stock discharge channel is formed,
the milling chamber is at least partially filled with grinding bodies having a diameter (c), and
above the internal stator there is arranged a grinding body separating device with a diameter (d30), and
a distance (s) between the rotor and the grinding body separating device is given by the relationship:
s=0.5·(d351−d30)≤5·c.

13. The stirrer mill according to claim 12, wherein the distance (s) between the rotor and the grinding body separating device is given by the relationship:
s=0.5·(d351−d30)≤3·c.

14. The stirrer mill according to claim 12, wherein distance s≤2 mm.

15. The stirrer mill according to claim 12, wherein the grinding body separating device comprises a cylindrical protective sieve.

16. The stirrer mill according to claim 12, wherein the tools, attached to the rotor, only leave free a small gap to the container wall, the gap between the tools and the container wall having a gap width (b) for which, relative to the diameter (c) of the grinding bodies, the relationship: 4c≤b≤6c applies, the minimum gap width (b) is given by 1.0 mm≤b≤2.0 mm.

17. The stirrer mill according to claim 12, wherein scraper tools, that extend toward the rotor, are arranged on the internal stator.

18. The stirrer mill according to claim 17, wherein the scraper tools arranged on the internal stator overlap one another in a direction of the central longitudinal axis and are arranged on the internal stator in such a manner that when the rotor is driven, the scraper tools exert an impulse directed in a through-flow direction on the grinding bodies.

19. The stirrer mill according to claim 18, wherein between the scraper tools and the rotor a gap is formed, for the gap width (e) of which, relative to the diameter (c) of the grinding bodies, the relationship: 4c≤e≤6c applies, and the minimum gap width (e) is given by: 1.0 mm≤c≤2.0 mm.

20. The stirrer mill according claim 12, wherein second tools are arranged on the container wall, which extend toward the rotor.

21. The stirrer mill according to claim 12, wherein in the stirring mechanism grinding body return channels are formed for returning the grinding bodies from the area of the grinding body separating device back into the milling chamber.

22. The stirrer mill according claim 12, wherein the diameter (c) of the grinding bodies is given by:
c≤0.65 mm and preferably 0.02 mm≤c≤0.3 mm.
